(19) United States
(12) Patent Application Publication
(10) Pub. No.: US 2014/0081819 A1
(43) Pub. Date: Mar. 20, 2014

(54) Processing Fixed Unit Financial Instruments

(71) Applicant: CHICAGO MERCANTILE EXCHANGE INC., Chicago, IL (US)

(72) Inventors: Richard Co, Chicago, IL (US); John Nyhoff, Darien, IL (US); Lucy Wang, Chicago, IL (US); Steve Youngren, Elgin, IL (US); John Labuszewski, Westmont, IL (US)

(73) Assignee: CHICAGO MERCANTILE EXCHANGE INC., Chicago, IL (US)

(21) Appl. No.: 13/622,748

(22) Filed: Sep. 19, 2012

(51) Int. Cl. G06Q 40/04

(52) U.S. Cl. 705/37

(57) ABSTRACT

Systems and methods are provided for processing fixed unit futures contracts. The initial notional value of a fixed unit futures contract is set to a round number. As the value changes over time, gains and losses are settled and the value of the fixed unit futures contract is returned to the notional value. The value of the fixed unit futures contract may begin each trading session at the notional value.

### FIELD OF THE INVENTION

Aspects of the present invention relate to the processing of orders and clearing of trades of financial instruments. More specifically, aspects of the present invention provide systems and methods for processing fixed unit futures contracts.

### BACKGROUND

Futures contracts are conventionally based on specific quantities of underlying assets. For example, a futures contract may be based on 5,000 bushels of soybeans, 1,000 barrels of crude oil or $50 times the value of the Standard & Poor (S&P) 500 Index. Since these contracts are based on fixed quantities, the values of the contracts fluctuate over time.

The fluctuating values of futures contracts can make futures contracts less than ideal for hedging risks associated with the purchase of over-the-counter derivatives. Over-the-counter derivatives, such as interest rate swaps, generally have constant notional values that are round numbers. As a result, it becomes difficult to precisely hedge the purchase of an over-the counter derivative that has a constant round value with a futures contract that may have a fluctuating value that is not a round value. The difficulty associated with not being able to precisely hedge a risk can make it difficult to comply with accounting standards or regulations.

Many retail investors also generally prefer to invest specific round dollar amounts instead of quantities. For example, an investor wishing to invest $10,000 in an oil futures contract would have to find a round quantity that has a value closest to $10,000.

Therefore, there is a need in the art for improved systems and methods for processing futures contracts.

### SUMMARY OF THE INVENTION

Embodiments of the invention overcome at least some of the problems and limitations of the prior art by providing systems and methods for creating and processing fixed unit futures contracts. The notional value of the fixed unit futures contract may be initially set to a round number. A computer system may be used to periodically determine gains and losses. The periods may correspond to trading sessions, fiscal periods or times agreed to by buyers and sellers. At the expiration of the time periods gains and losses may be determined and settled by a clearing firm. The value of the fixed unit futures contract may be returned to the notional value before the beginning of a trading session or other time period.

In various embodiments, aspects of the present invention can be partially or wholly implemented on a computer-readable medium, for example, by storing computer-executable instructions or modules, or by utilizing computer-readable data structures.

Of course, the methods and systems disclosed herein may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates the value of a fixed unit futures contract over time in accordance with an embodiment of the invention.

FIG. 3 illustrates a process that may be used to process fixed unit futures contracts in accordance with an embodiment of the invention.

### DETAILED DESCRIPTION

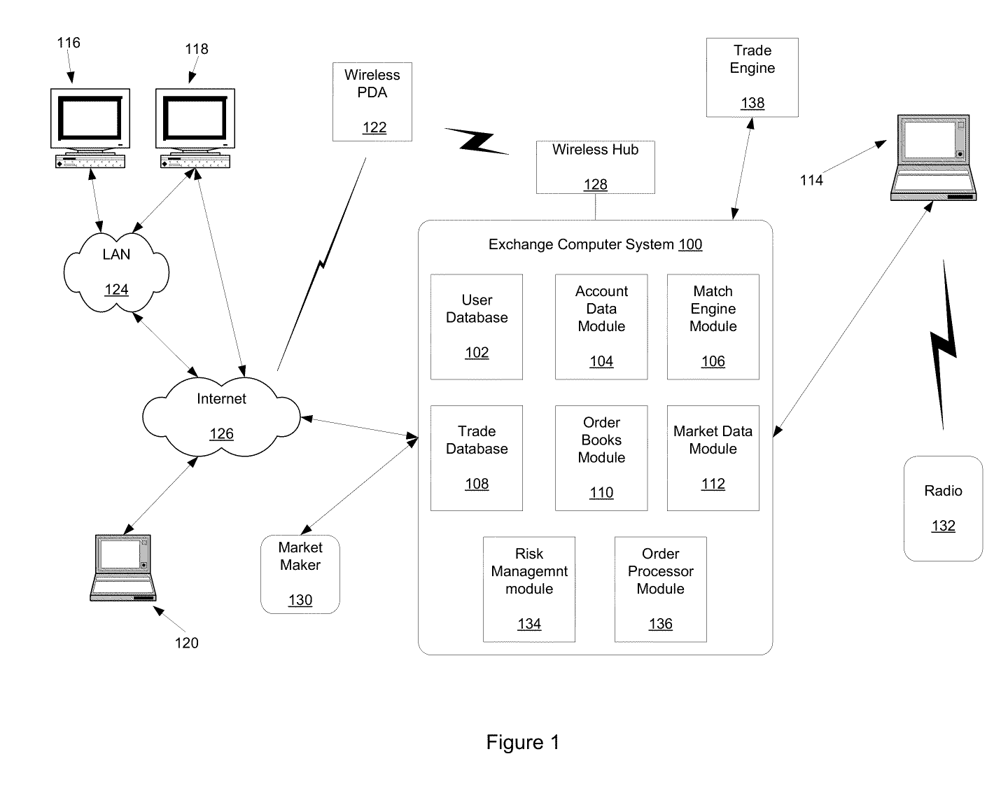

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.)

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

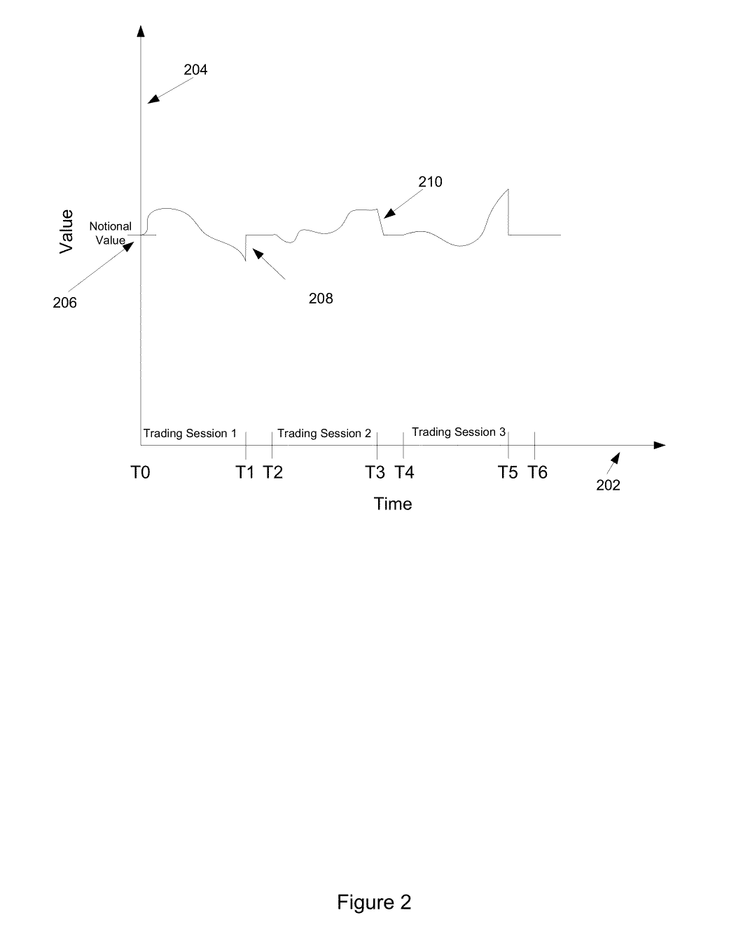

FIG. 2 illustrates the value of a fixed unit futures contract over time in accordance with an embodiment of the invention. The fixed unit futures contract may be based on a variety of underlying assets, such as equities, fixed income instruments, currencies, commodities and indexes. A time axis 202 is marked with times T0, T1, T2, T3, T4, T5 and T6. A value axis 204 is marked with a notional value 206. A fixed unit futures contract may initially have a notional value 206. The notional value may be a constant round number, such as $10,000 or $50,000. FIG. 2 shows a trading session 1 occurring between times T0 and T1. At time T0, the value of the fixed unit futures contract starts at notional value 206. Between times T0 and T1, the value may fluctuate. At time T1, the value of the fixed unit futures contract is less than notional value 206. After trading session 1 ends at time T1, the value of the fixed unit futures contract returns to notional value 206 so that at time T2, which corresponds to the beginning of trading session 2, the value of the fixed unit futures contract is recalibrated to notional value 206. Segment 208 represents a loss in value experienced during trading session 1. A clearing system may be used to clear the loss. Alternatively, the parties to a fixed unit futures contract may settle gains and losses directly with one another.

The value of the fixed unit futures contract may similarly fluctuate during trading session 2. After the end of trading session 2, which corresponds to time T3, the value of the fixed unit futures contract is recalibrated to notional value 206. FIG. 2 shows that the recalibration does not have to occur immediately after time T3. In some embodiments the recalibration occurs immediately after a trading session ends and in other embodiments the recalibration occurs at some time before the beginning of the next trading session. FIG. 2 also shows the fixed unit futures contract gaining value during trading session 2. Segment 210 represents the gain experienced during trading session 2. This gain may be cleared with a clearing system.

The value of the fixed unit futures contract may fluctuate during additional trading sessions or time periods and the value may be recalibrated to the notional value prior to the beginning of another trading session or time period. A clearing system may be used to clear gains and losses. Gains and loss may also be accumulated and cleared after multiple trading sessions or time periods. For example, gains and losses may be tracked daily and clearing of accumulated gains and losses may occur once per fiscal quarter.

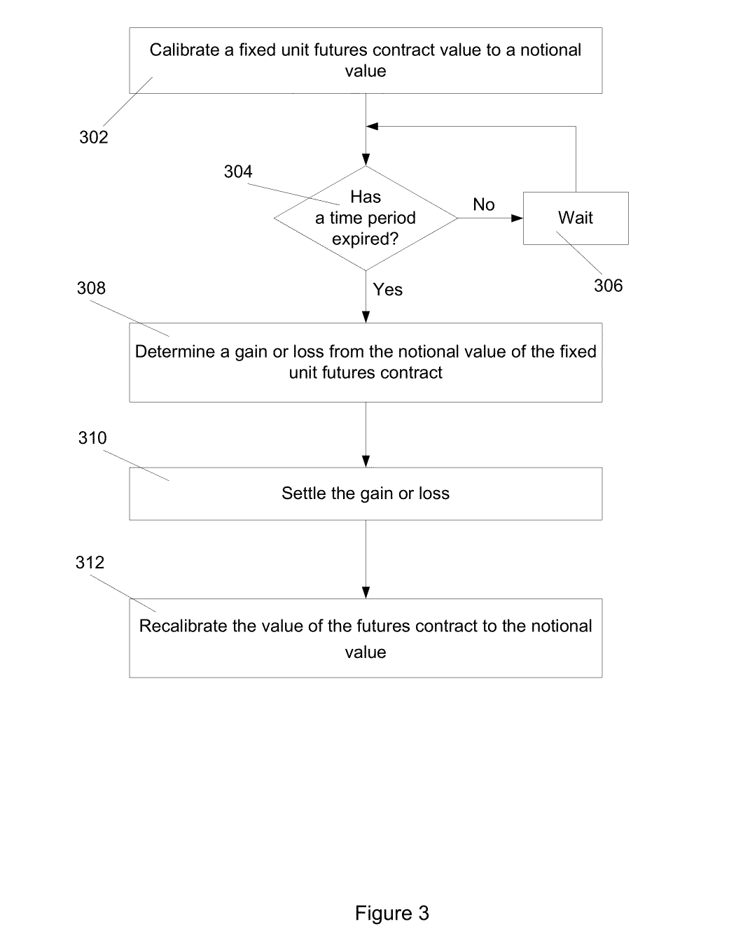

FIG. 3 illustrates a process that may be used to process fixed unit futures contracts in accordance with an embodiment of the invention. First, in step 302 a fixed unit futures contract value is calibrated to a notional value. The notional value may be a round number. The calibration may occur at the beginning of a trading session or other time period. Next, it is determined whether a time period has expired in step 304. Step 304 may include determining whether a trading session has ended. In alternative embodiments the time period may correspond to an end of a month, fiscal quarter or a time agreed to by a buyer and seller of the fixed unit futures contract. If the time period has not expired, in step 306 the process waits for a predetermined time period and checks again to see if the time period has expired. In an alternative embodiment, instead of determining whether a time period has expired, the process may receive a notice when the time period has expired.

After the time period has expired, in step 308 a gain or loss from the notional value of the fixed unit futures contract is determined. Step 308 may be performed with a processor of a computer system. Next, any gain or loss is settled in step 310. Step 310 may be performed by a clearing firm computer system or some other computer system and may include debiting and crediting accounts of a buyer and a seller of the fixed unit futures contract. The value of the futures contract may be recalibrated to the notional value in step 312. Step 312 may be performed after the expiration of trading session and prior to the beginning of a new trading session.

The present invention has been described in terms of preferred and exemplary embodiments thereof. Numerous other embodiments, modifications and variations within the scope and spirit of the invention will occur to persons of ordinary skill in the art from a review of this disclosure.

1. A method of clearing a fixed unit futures contract comprising:
(a) at the expiration of a time period, determining at a processor a gain or loss from a constant round notional value of a fixed unit futures contract;
(b) settling the gain or loss; and
(c) recalibrating at a computer processor the value of the futures contract to the constant round notional value at the expiration of the time period.

2. The method of claim 1, wherein the time period in (a) is a trading session.

3. The method of claim 1, wherein (b) comprises cash settling the gain or loss.

4. The method of claim 1, wherein (b) comprises physical delivery of an underlying asset.

5. The method of claim 1, wherein (b) comprises cash settling a portion of the gain or loss and physical delivery of an underlying asset.

6. The method of claim 1, further including:
(d) at the expiration of a second time period, determining a gain or loss from the constant round notional value of the fixed unit futures contract;
(e) settling the gain or loss determined in (d); and
(f) recalibrating the value of the futures contract to the constant round notional value at the expiration of the second time period.

7. The method of claim 1, wherein an underlying asset of the fixed unit futures contract comprises an index.

8. The method of claim 7, wherein the index comprises an S&P 500 index.

9. The method of claim 7, wherein the index comprises a total return index.

10. The method of claim 1, wherein an underlying asset of the fixed unit futures contract comprises an agricultural product.

11. A computer executable non-transitory tangible storage medium having computer instructions that cause a computer device to perform the steps comprising:
(a) at the expiration of a time period, determining at a processor a gain or loss from a constant round notional value of a fixed unit futures contract;
(b) settling the gain or loss; and
(c) recalibrating at a processor the value of the futures contract to the constant round notional value at the expiration of the time period.

12. The computer executable non-transitory tangible storage medium of claim 11, wherein the time period in (a) is a trading session.

13. The computer executable non-transitory tangible storage medium of claim 11, wherein (b) comprises cash settling the gain or loss.

14. The computer executable non-transitory tangible storage medium of claim 11, wherein (b) comprises physical delivery of an underlying asset.

15. The computer executable non-transitory tangible storage medium of claim 11, wherein (b) comprises cash settling a portion of the gain or loss and physical delivery of an underlying asset.

16. The computer executable non-transitory tangible storage medium of claim 11, further including computer instructions that cause a computer device to perform the steps comprising:
(d) at the expiration of a second time period, determining a gain or loss from the constant round notional value of the fixed unit futures contract;
(e) settling the gain or loss determined in (d); and
(f) recalibrating the value of the futures contract to the constant round notional value at the expiration of the second time period.

17. The computer executable non-transitory tangible storage medium of claim 11, wherein an underlying asset of the fixed unit futures contract comprises an index.

18. A computer system comprising:
at least one processor; and
a tangible memory containing computer executable instructions that when executed cause the at least one processor to perform the steps comprising:
(a) periodically determining a gain or loss of a from a constant round notional value of a fixed unit futures contract and recalibrating the value of the futures contract to the constant round notional value.

19. The computer system of claim 18, wherein the tangible memory further contains computer instructions that cause the at least one processor to perform the step comprising:
(b) periodically settling gains and losses.

20. The computer system of claim 18, wherein an underlying asset of the fixed unit futures contract comprises an index.
